(19) United States
(12) Patent Application Publication
(10) Pub. No.: US 2004/0105656 A1
(43) Pub. Date: Jun. 3, 2004

(54) Information processing apparatus

(75) Inventors: Masaki Shimada, Tokyo (JP); Kunio Nakano, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Holdings, Inc., Tokyo (JP)

(21) Appl. No.: 10/723,822

(22) Filed: Nov. 24, 2003

(30) Foreign Application Priority Data
Nov. 29, 2002 (JP) 2002-349025

(51) Int. Cl. H04N 5/76; H04N 5/781

(52) U.S. Cl. 386/46; 386/125

(57) ABSTRACT

There is provided an information processing apparatus which has the versatility of allowing connection to an external device and can easily transfer digital information from one recording medium to another recording medium. When an external MO drive is connected to an external device such as a personal computer, the drive can transmit/receive digital information to/from the device. When a copy button is operated while the personal computer is not connected to the drive, the drive can read out image files from a memory card inserted in a PC card slot portion and write the files in an MO disk inserted in an MO disk slot portion. This therefore facilitates backup of files.

### BACKGROUND OF THE INVENTION

1. Field of the Invention

The present invention relates to an information processing apparatus and, more particularly, to an information processing apparatus which allows insertion/ejection of a plurality of recording media and can transfer digital information from one recording medium to another recording medium.

2. Description of the Prior Art

The images photographed by a digital camera such as a digital still camera are recorded as digital information such as image files on a recording medium (memory card or the like) inserted in the camera. The recorded digital information is transferred to a personal computer or the like to be used. In many digital camera, therefore, in order to facilitate data handling at the time of transfer, the same file system as that in the personal computer is formed on a recording medium, and each photographed image is generally recorded as one image file (see Japanese Unexamined Patent Publication No. 11-164234).

Many memory cards and the like have the size of a postage stamp because of importance to portability and generally have small storage capacities. As photographing operation is continued by using a digital camera, the remaining storage capacity of the memory card decreases, resulting in inability of the camera to perform photographing operation. If the image files stored in the memory card are recorded (copied) on another recording medium, the image files in the memory card can be erased. This makes it possible to perform new photographing operation using the same memory card.

According to a general form of transferring records to another recording medium in this manner, for example, image files are read out from a digital camera onto a personal computer through a USB (Universal Serial Bus). The images files are then written in another recording medium having a larger capacity. This operation is called backup.

In order to back up files in a memory card, the user himself/herself must copy the image files by operating a personal computer. Therefore, it takes much time and labor to back up files. In contrast to this, a dedicated apparatus for reading out image files from the card and writing the files on another recording medium may be manufactured. Such dedicated apparatus can save operation but has poor versatility. The information processing apparatus is low in value as a product.

### SUMMARY OF THE INVENTION

The present invention has been made in consideration of the above problems in the prior art, and has as its object to provide an information processing apparatus which has the versatility of allowing connection to an external device and can easily transfer digital information (records) from one recording medium to another recording medium.

In order to achieve the above object, according to the first aspect of the present invention, there is provided an information processing apparatus comprising a first insertion/ejection portion in/from which a first recording medium can be inserted/ejected and which can at least read out digital information from the inserted first recording medium, a second insertion/ejection portion in/from which a second recording medium can be inserted/ejected and which can read out and write digital information from and in the inserted second recording medium, a control unit, and an operating member which starts operation of reading out digital information from the first recording medium and writing the information in the second recording medium, wherein the first and second insertion/ejection portions are connected to be capable of transmitting/receiving digital information, and the control unit searches for digital information recorded on the first recording medium inserted in the first insertion/ejection portion in accordance with operation of the operating member, buffers date data of a file, of the found files, which is set at a predetermined rank, creates a new directory in the second recording medium inserted in the second insertion/ejection portion, writes the buffered date data as a creation date of the directory, and writes all the digital information recorded on the first recording medium into the newly created directory.

When this apparatus is connected to an external device such as a personal computer, the apparatus allows transmission/reception of digital information to/from the device. When the operating member is operated while no external device is connected to the apparatus, the apparatus can read out digital information from the first recording medium inserted in the first insertion/ejection portion and write the information on the second recording medium inserted in the second insertion/ejection portion. This makes it easy to back up files. In addition, since buffered date data is used as the creation date of the directory, a search for backed-up data can be easily performed on the basis of the creation date.

According to the second aspect of the present invention, the information processing apparatus described in the first aspect further comprises a connecting portion which can be connected to an external device, the first insertion/ejection portion, the second insertion/ejection portion, and the connecting portion are connected such that digital information can be transmitted/received from one of the portions to another portion, and the control unit permits transmission/reception of digital information, through the connecting portion, between the external device and the first recording medium inserted in the first insertion/ejection portion and/or the second recording medium inserted in the second insertion/ejection portion when detecting that the external device is connected through the connecting portion, and inhibits transmission/reception of digital information through the connecting portion when not detecting that the external device is connected through the connecting portion.

With this arrangement, when, for example, an external device such as a personal computer is connected to the information processing apparatus, the apparatus can be used as an eternal storage device. This increases the value of the product.

According to the third aspect, in the information processing apparatus described in the second aspect, when detecting that the external device is connected through the connecting portion, the control unit reads out digital information from the first recording medium inserted in the first insertion/ejection portion and inhibiting a direct write in the second recording medium inserted in the second insertion/ejection portion even if the operating portion is operated.

This can avoid contention between transfer control by the eternal device and transfer control by the control unit, and hence unnecessary troubles.

According to the fourth aspect of the present invention, an information processing apparatus comprising a first insertion/ejection portion in/from which a first recording medium can be inserted/ejected and which can at least read out digital information from the inserted first recording medium, a second insertion/ejection portion in/from which a second recording medium can be inserted/ejected and which can read out and write digital information from and in the inserted second recording medium, a connecting portion which can be connected to an external device, a control unit, and an operating member which starts operation of reading out digital information from the first recording medium and writing the information in the second recording medium, wherein the first insertion/ejection portion, the second insertion/ejection portion, and the connecting portion are connected such that digital information can be transmitted/received from one of the portions to another portion, in accordance with operation of the operating member, while detecting that the external device is connected through the connecting portion, the control unit permits the external device to read out digital information from the first recording medium inserted in the first insertion/ejection portion and transfer the information to the external device and to write, in the second recording medium inserted in the second insertion/ejection portion, digital information transferred from the external device through the connecting portion, and the external device searches for digital information recorded on the first recording medium inserted in the first insertion/ejection portion, buffers date data of a file, of the found files, which is set at a predetermined rank, creates a new directory in the second recording medium inserted in the second insertion/ejection portion, writes the buffered date data as a creation date of the directory, and writes all the digital information recorded on the first recording medium into the newly created directory.

With this arrangement, when the operating member is operated while the apparatus is connected to the external device such as a personal computer, the apparatus can read out digital information from the first recording medium inserted in the first insertion/ejection portion and write the information in the second recording medium inserted in the second insertion/ejection portion. This can avoid contention between transfer control by the external device and transfer control by the control unit. In addition, files can be easily backed up. In addition, since the buffered date data are used as the creation date of the directory, a search for backed-up data can be efficiently performed on the basis of the creation date.

According to the fifth aspect of the present invention, a name of the new directory described in the first or forth aspect is created on the basis of the buffered date data.

The name of a directory for the storage of image information in the second recording medium is determined by using date data such as the creation date and/or creation time of a recorded file. This makes it unnecessary to provide a real-time clock or the like for independently determining a directory mane. Therefore, a simple, low-cost arrangement can be provided.

According to the sixth aspect of the present invention, the file at the predetermined rank which is described in the first or fourth aspect is a file found first by a search.

The file at the predetermined rank is preferably the file found first because the search time can be shortened. However, this file may be a file found second, third, or last. In addition, a search for a plurality of files may be made, and the creation dates or the like of them may be stored.

According to the seventh aspect of the present invention, the search described in the sixth aspect is performed for only a file with a specific extension (JPEG or the like).

Although a search is preferably made for only files with a specific extension (JPEG or the like) because the contents of files are narrowed down, a search may be made for all files. Alternatively, files may be determined by attribute data such as inhibition of the use of hidden files or the like.

According to the eighth aspect of the present invention, the control unit in the information processing apparatus described in the first to seventh aspects creates, in the second recording medium, a directory having a name including a creation date and/or a creation time of the recorded file, and then transfers digital information recorded on the first recording medium to the directory.

This arrangement is preferable because it suppresses the overlap of directory names.

According to the ninth aspect of the present invention, the control unit in the information processing apparatus described in the first to eighth aspects creates a name attached to a created directory in the second recording medium so as to indicate a directory creation order.

This avoids the overlap of directory names and facilitates subsequent searches.

According to the 10th aspect of the present invention, during writing of digital information in the second recording medium, even when detecting that the operating member is operated, the control unit in the information processing apparatus described in the first to ninth aspects inhibits control based on the operation.

This can prevent an operation error due to an interruption during writing of digital information.

According to the 11th aspect of the present invention, during writing of digital information in the second recording medium, even when detecting that the external device is connected through the connecting portion, the control unit in the information processing apparatus described in the second and third aspects and the fifth to 10th aspects inhibits transmission/reception of digital information to/from the external device until digital information is completely written in the second recording medium.

This can prevent an operation error due to an interruption during writing of digital information.

In the present invention, the first recording medium is preferably an optical information recording medium such as a memory card, CD-R, or DVD-R or a magnetooptic information recording medium such as an MO. The second recording medium is preferably an optical information recording medium such as a CD-R or DVD-R, a magnetooptic information recording medium such as an MO, a hard disk, or the like, and more preferably a medium having a larger capacity than the first recording medium. The control unit is preferably capable of creating a file system by, for example, formatting the second recording medium. The information processing apparatus preferably includes a display unit and/or a sound generating unit which indicates the transmission/reception state of image information. Digital information includes an image file, and also includes various kinds of data such as document data and CG data. A port such as a USB may be attached to the first insertion/ejection portion to allow connection of a digital still camera and other kinds of storage devices in place of the first recording medium.

The date data of a found file (a file recorded on the first recording medium, e.g., a memory card) includes a creation date, correction date, creation time, and correction time. Of these data, as the creation date/time of a new directory, the creation date/time of an original file is used. However, the correction date/time of an original file may be used. A text is created on the basis of the creation date of an original file is used as the name of a new directory. This operation, however, may be done on the basis of the correction date. In addition, an update date and/or update time may be used in place of a creation date and/or creation time. In addition, a file on which a directory name is based may differ from a file on which the creation of a directory is based.

As is obvious from the above description, according to the present invention, there is provided an information processing apparatus which has the versatility of allowing connection to an external device and can easily transfer digital information from one recording medium to another recording medium.

The above and many other objects, features and advantages of the present invention will become manifest to those skilled in the art upon making reference to the following detailed description and accompanying drawings in which preferred embodiments incorporating the principle of the invention are shown by way of illustrative examples.

### BRIEF DESCRIPTION OF THE DRAWINGS

FIG. 1 is a schematic perspective view of an external MO drive according to an embodiment of the present invention;

FIG. 2 is a functional block diagram showing the internal arrangement of an external MO drive in FIG. 1;

FIG. 3 is a flow chart showing control operation in the external MO drive in FIG. 1;

FIG. 4 is a view showing an example of the file system created in a memory card in the external MO drive in FIG. 1;

FIG. 5 is a view showing an example of the file system created in an MO disk; and

FIG. 6 is a functional block diagram showing the internal arrangement of an external MO drive according to another embodiment of the present invention.

### DETAILED DESCRIPTION OF THE PREFERRED EMBODIMENTS

Several preferred embodiments of the present invention will be described in detail below with reference to the accompanying drawings.

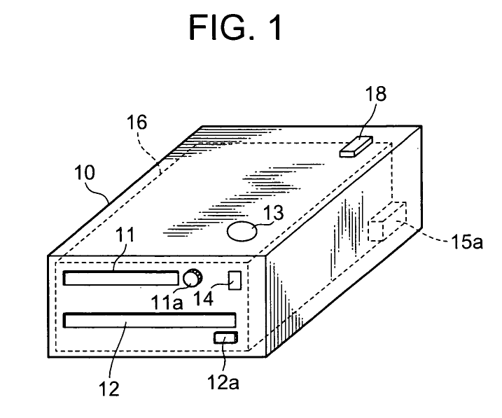

In an external MO drive according to an embodiment of the present invention shown in FIG. 1, the front surface of a housing 10 has a memory card slot portion 11 serving as the first insertion/ejection portion, an MO disk slot portion 12 serving as the second insertion/ejection portion, and an LED 14 serving as a display unit. A USB connector 15a serving as a connecting portion is provided on the rear surface of the housing 10. A copy button 13 and power switch 18 serving as operating members are arranged on the upper surface of the housing 10. An eject button 11a for ejecting an inserted memory card (e.g., a PC card) 11b with an adaptor is provided on a side of the memory card slot portion 11, and an eject button 12a for ejecting an inserted MO disk 12b is provided below the MO disk slot portion 12. A control unit 16 can detect the operation of the copy button 13 by receiving an ON signal from it.

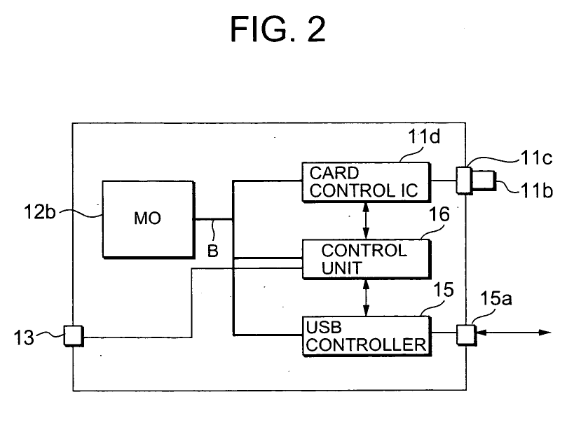

FIG. 2 is a functional block diagram showing the internal arrangement of the external MO drive in FIG. 1. This drive includes the memory card 11b (including a connector 11c of the memory card 11b and a card control IC 11d) capable of reading out and writing digital information, the MO disk 12b capable of reading out and writing digital information, a USB controller 15 having the USB connector 15a, the control unit 16, and the like.

The control unit 16 is connected to the memory card 11b and MO disk 12b through a bus B so as to be communicable with each of them. The control unit 16 has a function of detecting whether the drive is connected to external equipment such as a personal computer through the USB controller 15 and a cable, and controlling transmission/reception of digital information between the memory card 11b and the MO disk 12b.

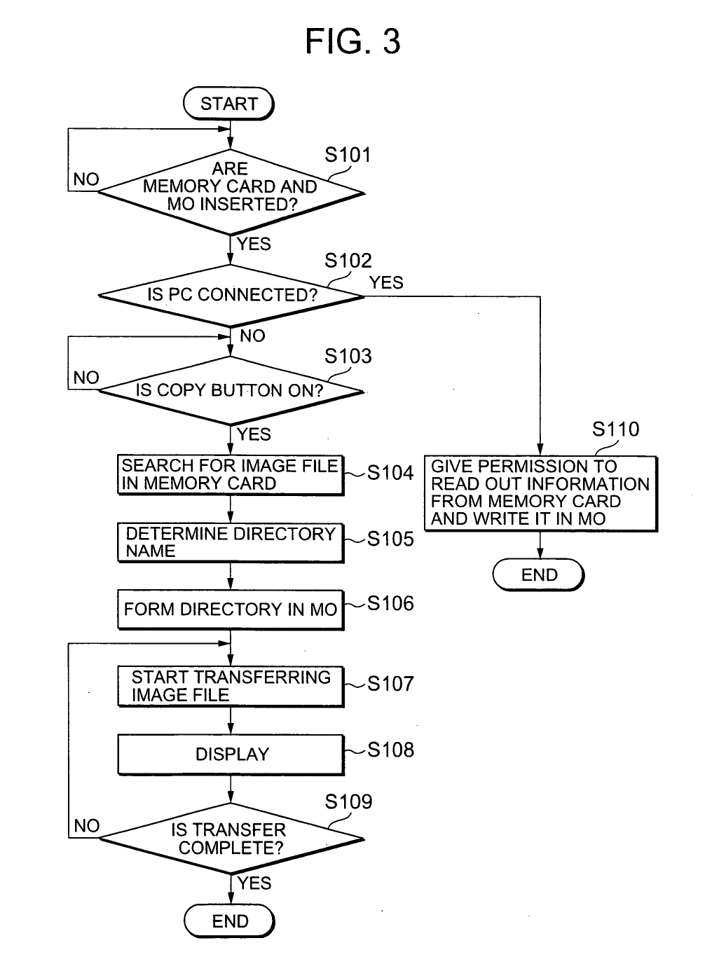

FIG. 3 is a flow chart showing the control operation of the control unit 16. Referring to FIG. 3, in step S101, the control unit 16 checks whether the memory card 11b with the adaptor is inserted in the memory card slot portion 11 and the MO disk 12b is inserted in the MO disk slot portion 12. Upon determining that both of them are inserted, the control unit 16 further checks in step S102 whether the drive is connected to an external personal computer through the USB controller 15.

Upon detecting that the drive is connected to an external personal computer, the control unit 16 permits in step S110 to read out or write digital information from or in the memory card 11b in the memory card slot portion 11 or to or from the MO disk 12b in the MO disk slot portion 12 through the USB controller 15 under the control of the external personal computer. That is, the external MO drive operates as an external storage device as an original function. In this case, the operation of the copy button 13 is ignored to inhibit direct file transfer from the memory card 11b to the MO disk 12b.

If the control unit 16 determines that the drive is not connected to any external personal computer, in step S103 the control unit 16 waits until the copy button 13 is pressed. When the user presses (operates) the copy button 13, the control unit 16 searches for an image file (e.g., a file with the extension “JPEG”) recorded on the memory card 11b, and stores (buffers) the creation date/time of the first image file in a built-in memory in step S104. Subsequently, the control unit 16 determines a directory name in step S105.

In this case, a directory name may be determined as follows. If, for example, the stored creation date is 2002 (year) 11 (month) 18 (day), the date is directly used as the name “021118”. If a plurality of directories may be created on the same day, a date and serial numbers may be combined to name the directory created first as “021118.001” and the directory created next as “021118.002. In addition to the above methods, various methods are conceivable, e.g., a method of forming a combination of a date and time like “021118_{—}1325 (13 (hr) 25 (min)) and a method of forming a combination of letters and a date like “IM02118”.

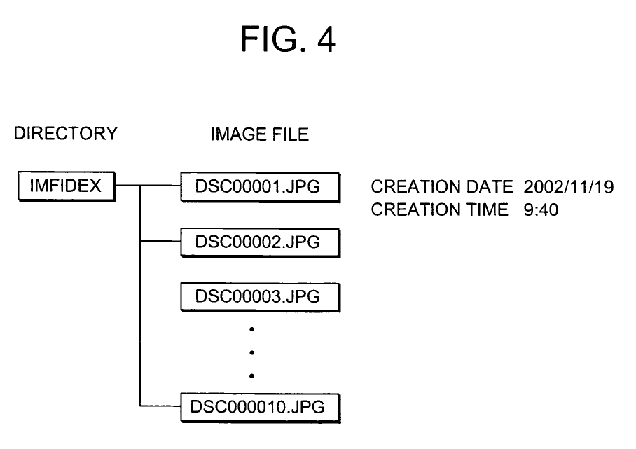

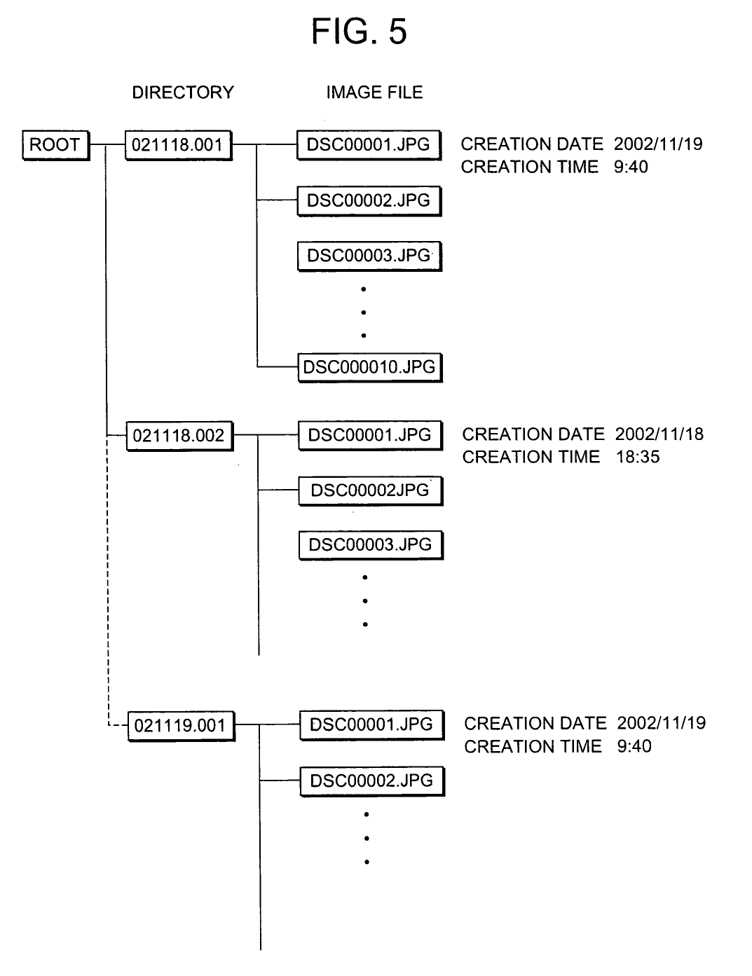

Assume that the file system shown in FIG. 4 is created in the memory card 11b in advance. The control unit 16 searches the root directory of the file system in FIG. 4 to store the creation date (or update date) of the first image file “2002/11/18” and the creation time (or update time) “9:40” in the built-in memory. The control unit 16 then searches the file system (see FIG. 5) created in the MO disk 12b to check whether there is any directory having the same name as “021118”. If there is no such directory, “021118.001” is determined as a new directory name. If there is such a directory, the portion other than the creation date, i.e., the serial number “.00*”, is changed to determine a directory name that can be discriminated.

If a directory is found in the root directory, the control unit 16 further moves to the lower directory to search for files. If no file or directory is found, the control unit 16 returns to the root directory to store the creation date and the like of the first directory. Upon finding a file having no creation date set, the control unit 16 may search for another file, ignoring such a file, or use a date like “00/00/00”.

In addition, in step S106 in FIG. 3, the control unit 16 creates a new directory named “021118.001” in the file system of the MO disk 12b. In this case, the creation date and/or the creation time of the new directory “021118.001” created in the MO disk 12b should be identical to that of the files. In step S107, the control unit 16 starts to transfer all the files “DSC00001.JPG”, “DSC00002.JPG”, . . . in the memory card 11b into the directory “021118.001”. Note that the LED 14 blinks during file transfer to give a warning to the user so as not to withdraw the memory card 11b or MO disk 12b because of the file transfer (step S108). Even if the copy button 13 is operated during this period, the control unit 16 ignores the operation or issues, to the MO drive, a command to inactivate the eject buttons 11a and 12a so as to inhibit ejection of the memory card 11b or MO disk 12b during the file transfer, thereby preventing an operation error. In addition, while digital information is written in the MO disk 12b, even if the control unit 16 detects connection to an external personal computer through the USB controller 15, the control unit 16 inhibits transmission/reception of digital information to/from the personal computer until the end of writing of digital information in the MO disk 12b. This can prevent any operation errors based on instructions from the personal computer. Upon determining the completion of the transfer in step S109, the control unit 16 terminates its operation.

According to the flow chart of FIG. 3, step S102 is performed after step S101. However, these operations may be performed in reverse order.

According to this embodiment, since the name and creation date of a directory are determined by using the creation date and the like of a file, the control unit 16 is only required to have a memory, but need not have any real-time clock, liquid crystal display device, or the like. In addition, since directory name contention is automatically avoided, an MO drive can be manufactured with a simple arrangement at a low cost. Since this drive can be manufactured with a small number of parts, the failure rate can be suppressed low. In addition, files can be backed up by only operating the copy button 13. This makes the drive become more user-friendly. Furthermore, since a directory name is determined by using the creation date and the like of the first file, the directory name can be used as an important clue to search for a file afterward.

As another embodiment, there is provided an arrangement designed to detect insertion of a memory card with an adaptor and an MO disk and transfer digital information from one to the other instead of operating a copy button 13 which operates an operating member.

Assume that an external MO drive according to still another embodiment is connected to an external personal computer through a USB controller 15. In this case, a trigger signal is transmitted to the external personal computer in accordance with the operation of a copy button 13. The personal computer then searches for image files (e.g., files with the extension “JPEG”) in a memory card such as a PC card, and stores the creation date/time of the first image file in a built-in memory. The personal computer determines a directory name in the above manner and creates the directory in the file system of the MO disk to transfer the image files into the directory. In this case, a control unit 16 has a function of permitting control from the external personal computer in accordance with the operation of the copy button 13.

According to still another embodiment, a directory name may be determined as follows without using the creation date of a file. For example, when the file system of an MO disk is searched, and directory names including at least numbers found, a directory name is so determined as to include a number obtained by adding 1 to the maximum number (or subtracting 1 from the minimum number). In this case, each number may have an arbitrary letter attached. This makes it possible to create directories with different names such that the number continuously increases (or decreases) to indicate the creation order like “B0001”, “B0002”, “B0003”, . . . . Therefore, directory name contention can be avoided. In addition, since the directories are arranged in, for example, the backup order, a file search is facilitated. The creation date of a directory is identical to that of the found files. This makes it possible to quickly search for a photographed image by using the creation date of the directory.

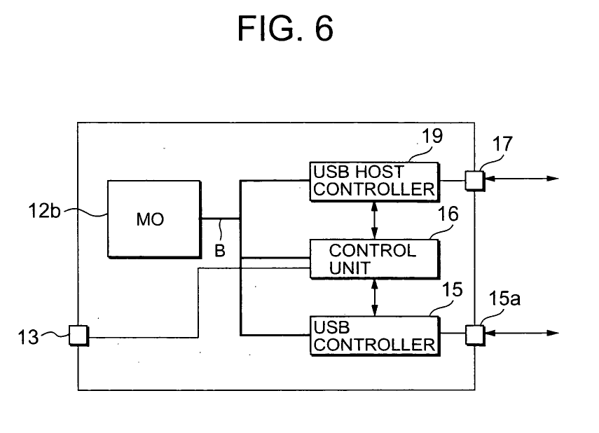

FIG. 6 is a functional block diagram of an external MO drive according to still another embodiment. The arrangement of this drive differs from that shown in FIG. 2 in that a USB host controller 19 and USB connector 17 are used in place of the card control IC 11d and connector 11c. According to this embodiment, once this drive is connected to an external storage device through the USB connector 17, digital information can be read/written from an MO disk 12b to the external storage device or in the reverse direction in the same manner as in the above embodiment by only operating a copy button 13.

Although several preferred embodiments of the present invention have been described above, it is to be understood that the present invention is not limited to any of the embodiments described above, and can be changed and modified as needed. For example, a memory card may be directly inserted into the external MO drive without any adaptor. Furthermore, in place of or in addition to the LED 14, a sound generating unit which generates a sound to indicate that a file is being transferred may be provided.

What is claimed is:

1. An information processing apparatus comprising:
a first insertion/ejection portion in/from which a first recording medium can be inserted/ejected and which can at least read out digital information from the inserted first recording medium;
a second insertion/ejection portion in/from which a second recording medium can be inserted/ejected and which can read out and write digital information from and in the inserted second recording medium;
control means; and
an operating member which starts operation of reading out digital information from the first recording medium and writing the information in the second recording medium,
wherein said first and second insertion/ejection portions are connected to be capable of transmitting/receiving digital information, and
said control means searches for digital information recorded on the first recording medium inserted in said first insertion/ejection portion in accordance with operation of said operating member, buffers date data of a file, of the found files, which is set at a predetermined rank, creates a new directory in the second recording medium inserted in said second insertion/ejection portion, writes the buffered date data as a creation date of the directory, and writes all the digital information recorded on the first recording medium into the newly created directory.

2. An apparatus according to claim 1, wherein
said information processing apparatus further comprises a connecting portion which can be connected to an external device,
said first insertion/ejection portion, said second insertion/ejection portion, and said connecting portion are connected such that digital information can be transmitted/received from one of said portions to another portion, and
said control means permits transmission/reception of digital information, through said connecting portion, between the external device and the first recording medium inserted in said first insertion/ejection portion and/or the second recording medium inserted in said second insertion/ejection portion when detecting that the external device is connected through said connecting portion, and inhibits transmission/reception of digital information through said connecting portion when not detecting that the external device is connected through said connecting portion.

3. An apparatus according to claim 2, wherein when detecting that the external device is connected through said connecting portion, said control means reads out digital information from the first recording medium inserted in said first insertion/ejection portion and inhibiting a direct write in the second recording medium inserted in said second insertion/ejection portion even if said operating portion is operated.

4. An information processing apparatus comprising:
a first insertion/ejection portion in/from which a first recording medium can be inserted/ejected and which can at least read out digital information from the inserted first recording medium;
a second insertion/ejection portion in/from which a second recording medium can be inserted/ejected and which can read out and write digital information from and in the inserted second recording medium;
a connecting portion which can be connected to an external device;
control means; and
an operating member which starts operation of reading out digital information from the first recording medium and writing the information in the second recording medium,
wherein said first insertion/ejection portion, said second insertion/ejection portion, and said connecting portion are connected such that digital information can be transmitted/received from one of said portions to another portion,
in accordance with operation of said operating member, while detecting that the external device is connected through said connecting portion, said control means permits the external device to read out digital information from the first recording medium inserted in said first insertion/ejection portion and transfer the information to the external device and to write, in the second recording medium inserted in said second insertion/ejection portion, digital information transferred from the external device through said connecting portion, and the external device searches for digital information recorded on the first recording medium inserted in said first insertion/ejection portion, buffers date data of a file, of the found files, which is set at a predetermined rank, creates a new directory in the second recording medium inserted in said second insertion/ejection portion, writes the buffered date data as a creation date of the directory, and writes all the digital information recorded on the first recording medium into the newly created directory.

5. An apparatus according to claim 1 or 4, wherein a name of the new directory is created on the basis of the buffered date data.

6. An apparatus according to claim 1 or 4, wherein the file at the predetermined rank is a file found first by a search.

7. An apparatus according to claim 6, wherein the search is performed for only a file with a specific extension.

8. An apparatus according to any one of claims 1 to 7, wherein said control means creates, in the second recording medium, a directory having a name including a creation date and/or a creation time of the recorded file, and then transfers digital information recorded on the first recording medium to the directory.

9. An apparatus according to any one of claims 1 to 8, wherein said control means creates a name attached to a created directory in the second recording medium so as to indicate a directory creation order.

10. An apparatus according to any one of claims 1 to 9, wherein during writing of digital information in the second recording medium, even when detecting that said operating member is operated, said control means inhibits control based on the operation.

11. An apparatus according to any one of claims 2 and 3 and 5 to 10, wherein during writing of digital information in the second recording medium, even when detecting that the external device is connected through said connecting portion, said control means inhibits transmission/reception of digital information to/from the external device until digital information is completely written in the second recording medium.
